(19) United States
(12) Patent Application Publication
(10) Pub. No.: US 2023/0128529 A1
(43) Pub. Date: Apr. 27, 2023

(54) ACCELERATION SYSTEM, METHOD AND STORAGE MEDIUM BASED ON CONVOLUTIONAL NEURAL NETWORK

(71) Applicant: Shenzhen Corerain Technologies Co., Ltd., Shenzhen (CN)

(72) Inventors: Chenglong Zeng, Shenzhen (CN); Yuanchao Li, Shenzhen (CN); Kuen Hung Tsoi, Shenzhen (CN); Xinyu Niu, Shenzhen (CN)

(21) Appl. No.: 18/145,028

(22) Filed: Dec. 22, 2022

Related U.S. Application Data
(63) Continuation of application No. PCT/CN2021/100236, filed on Jun. 16, 2021.

(30) Foreign Application Priority Data
Jun. 22, 2020 (CN) 202010575498.X

(51) Int. Cl. G06F 9/50; G06F 12/0802

(52) U.S. Cl. CPC G06F 9/5027; G06F 12/0802

(57) ABSTRACT

An acceleration system includes: a direct memory accessor configured to store a computation graph, a first data stream lake buffer and a second data stream lake buffer, the first data stream lake buffer being configured to cache the computation graph; an arithmetic unit configured to obtain an i-th layer of computing nodes of the computation graph to obtain an (i+1)-th layer of computing nodes; and the first fan-out device configured to replicate the (i+1)-th layer of computing nodes and store the same in the direct memory accessor and the second data stream lake buffer, respectively. The arithmetic unit extracts the (i+1)-th layer of computing nodes from the second data stream lake buffer to obtain a (i+2)-th layer of computing nodes, and the above steps are repeated until the n layer of computing nodes is obtained, where 1≤i≤n-3, n≥4, i is a positive integer, and n is a positive integer.

### CROSS REFERENCE TO RELATED APPLICATIONS

The present application is a Continuation Application of PCT Application No. PCT/CN2021/100236 filed on Jun. 16, 2021, which claims priority to a Chinese patent Application with Application Number 202010575498.X filed with the China Patent Office on Jun. 22, 2020, the entire contents of which are incorporated herein by reference.

### TECHNICAL FIELD

An embodiment of the present application relates to neural network technology, for example, to an acceleration system, method and storage medium based on a convolutional neural network.

### BACKGROUND

In recent years, deep learning algorithms have performed well in the field of machine learning and achieved important results. As a representative of deep learning, Convolutional Neural Networks (CNN) are widely used in object detection, classification and automatic driving.

Although the convolutional neural network algorithm is one of the most advanced algorithms in the field of machine vision, it faces the challenge of dealing with tasks of increasing complexity. This leads to the need to design deeper, more expressive networks at the expense of increased computation and storage requirements. Therefore, a dedicated acceleration platform is needed to accelerate the convolutional neural network. A Graphics Processing Unit (GPU) is the most commonly used platform for implementing convolutional neural networks, because it can provide relatively high computing power, but its power consumption is relatively large, and it is only suitable for cloud computing platforms. In order to provide a more professional convolutional neural network acceleration platform, in recent years, convolutional neural network accelerators based on Application Specific Integrated Circuit (ASIC) and Field Programmable Gate Array (Field Programmable Gate Array, FPGA) have become popular research topics. Among them, the accelerator using the data flow architecture has a high utilization rate of the multiplier and the adder, and the acceleration effect is the best under the same hardware platform.

During the computation process of the convolutional neural network, a large amount of intermediate data will be generated. Usually, the convolutional neural network accelerator based on the data flow architecture often transmits these intermediate data to the off-chip memory, and then sends them back to the on-chip memory when needed. If the convolutional neural network accelerator based on dataflow architecture is to achieve high utilization of multipliers and adders, it must ensure that valid data flows through the multipliers and adders every clock. However, due to the limitation of bandwidth, if the intermediate data is transmitted to the off-chip memory and then sent back to the on-chip memory when needed, it is difficult to ensure that there is valid data flowing through the multiplier and adder every clock, and there may even be a period of data cutoff, which seriously affects the acceleration effect of the accelerator and the utilization of computing resources.

### SUMMARY

The following is an overview of the topics described in detail in this disclosure. This overview is not intended to limit the scope of the claims.

Embodiments of the present application provide an acceleration system, method, and storage medium based on a convolutional neural network, so as to reduce the number of intermediate data transmissions to an off-chip memory during convolutional neural network computations to accelerate computations.

An embodiment of the present application provides an acceleration system based on a convolutional neural network. The acceleration system based on a convolutional neural network includes:
a direct memory accessor configured to store a computation graph, the computation graph comprising n layers of computing nodes;
a data stream lake buffer region, comprising a first data stream lake buffer and a second data stream lake buffer, the first data stream lake buffer being configured to cache an i-th layer of compute nodes of the computation graph;
an arithmetic unit configured to obtain the i-th layer of the computing nodes of the computation graph from the first data stream lake buffer for computation to obtain an (i+1)-th layer of the computing nodes;
a first fan-out device configured to replicate the (i+1)-th layer of the computing nodes and store the (i+1)-th layer of the computing nodes in the direct memory accessor and the second data stream lake buffer respectively, and the arithmetic unit extracting the (i+1)-th layer of the computing nodes from the second data stream lake buffer for computation to obtain an (i+2)-th layer of the computing nodes;
the first fan-out device is further configured to replicate the (i+2)-th layer of the computing nodes and store the (i+2)-th layer of the computing nodes in the direct memory accessor and the first data stream lake buffer, the arithmetic unit extracts the (i+2)-th layer of the computing nodes from the first data stream lake buffer for computation to obtain an (i+3)-th layer of the computing nodes, and repeats the above steps until a n-th layer of the computing nodes is obtained;
where, 1≤i≤n-3, n≥4, i is a positive integer, and n is a positive integer.

On the one hand, an embodiment of the present application provides an acceleration method based on a convolutional neural network. The acceleration method based on a convolutional neural network includes:
caching an i-th layer of computing nodes of a computation graph into a first data stream lake buffer to wait for computation, the computation graph comprising n layers of the computing nodes;
extracting the i-th layer of the computing nodes from the first data stream lake buffer for computation to obtain an (i+1)-th layer of the computing nodes;
replicating the (i+1)-th layer of the computing nodes, outputting the (i+1)-th layer of the computing nodes to the direct memory accessor and a second data stream lake buffer respectively;
extracting the (i+1)-th layer of the computing nodes from the second data stream lake buffer for computation to obtain an (i+2)-th layer of the computing nodes;
replicating the (i+2)-th layer of the computing nodes, outputting the (i+2)-th layer of the computing nodes to the direct memory accessor and the first data stream lake buffer respectively;
extracting the (i+2)-th layer of the computing nodes from the first data stream lake buffer for computation to obtain an (i+3)-th layer of the computing nodes, repeating the above steps until a n-th layer of the computing nodes is obtained;
where, 1≤i≤n-3, n≥4, i is a positive integer, and n is a positive integer.

On the other hand, the embodiment of the present application also provides a computer-readable storage medium, on which a computer program is stored, and when the program is executed by a processor, the acceleration method provided in any embodiment of the present application is implemented.

### BRIEF DESCRIPTION OF THE DRAWINGS

FIG. 1 is a schematic structural diagram of an acceleration system based on a convolutional neural network provided by an embodiment of the present application;

FIG. 2 is a schematic structural diagram of an acceleration system based on a convolutional neural network provided by another embodiment of the present application;

FIG. 3 is a schematic flowchart of an acceleration method based on a convolutional neural network provided by an embodiment of the present application; and

FIG. 4 is a schematic flowchart of an acceleration method based on a convolutional neural network provided by another embodiment of the present application.

### DETAILED DESCRIPTION

The application will be further described in detail below in conjunction with the accompanying drawings and embodiments. It should be understood that the exemplary embodiments described here are used to explain the present application rather than limit the present application. In addition, it should be noted that, for the convenience of description, only some structures related to the present application, but not all structures, are shown in the drawings.

Before discussing the exemplary embodiments in more detail, it should be mentioned that some exemplary embodiments are described as processes or methods depicted as flowcharts. Although the flowcharts describe the steps as sequential processing, many of the steps may be performed in parallel, concurrently, or simultaneously. Additionally, the order of steps may be rearranged. A process may be terminated when its operations are complete, but may also have additional steps not included in the drawings. A process may correspond to a method, function, procedure, subroutine, subprograms, or the like.

In addition, the terms “first”, “second”, etc. may be used herein to describe various directions, actions, steps or elements, etc., but these directions, actions, steps or elements are not limited by these terms. These terms are only used to distinguish a first direction, action, step or element from another direction, action, step or element. For example, a first fan-out device could be termed a second fan-out device, and similarly, a second fan-out device could be termed a first fan-out device, without departing from the scope of the present application. Both the first fan-out device and the second fan-out device are fan-out devices, but they are not the same fan-out devices. The terms “first”, “second”, etc. should not be understood as indicating or implying relative importance or implying the number of technical features indicated. Thus, a feature defined as “first” or “second” may explicitly or implicitly include one or more of the features. In the description of the embodiments of the present application, “plurality” means at least two, such as two, three, etc., unless otherwise expressly and specifically defined.

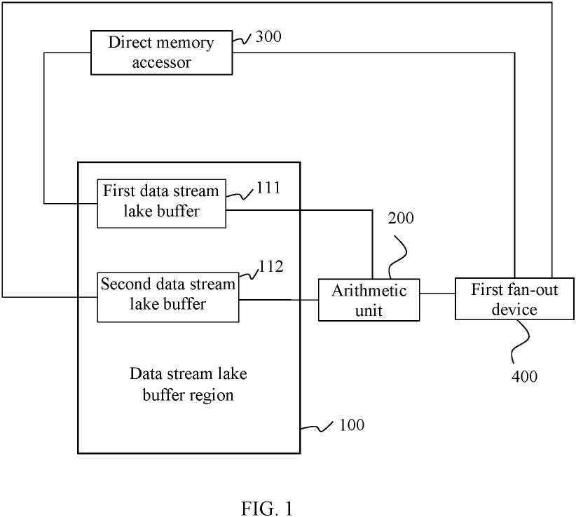

As shown in FIG. 1, an embodiment of the present application provides an acceleration system based on a convolutional neural network. The acceleration system based on a convolutional neural network includes a direct memory accessor 300, a data stream lake buffer region 100, an arithmetic unit 200 and a first fan-out device 400.

In this embodiment, the direct memory accessor 300 is configured to store a computation graph, and the computation graph includes n layers of computing nodes; the data stream lake buffer region 100 includes a first data stream lake buffer 111 and a second data stream lake buffer 112. The first data stream lake buffer 111 is configured to cache an i-th layer of compute nodes of the computation graph; the arithmetic unit 200 is configured to obtain the i-th layer of compute nodes of the computation graph from the first data stream lake buffer 111 to perform computations to obtain the (i+1)-th layer of computing nodes; the first fan-out device 400 is configured to replicate the (i+1)-th layer of computing nodes and store them in the direct memory accessor 300 and the second data stream lake buffer 112 respectively. The arithmetic unit 200 extracts the (i+1)-th layer of computing nodes from the second data stream lake buffer 112 to perform computations to obtain the (i+2)-th layer of computing nodes, and the first fan-out device 400 is also configured to replicate the (i+2)-th layer of computing nodes and stored them in the direct memory accessor 300 and the first data stream lake buffer 111, and the arithmetic unit 200 extracts the (i+2)-th layer of computing nodes from the first data stream lake buffer 111 to perform computations to obtain the (i+3)-th layer of computing nodes, the above steps are repeated until the n-th layer of computing nodes is obtained, where 1≤i≤n-3, n≥4, i is a positive integer, and n is a positive integer.

For example, the direct memory accessor 300 is a hardware module of a direct memory access (Direct Memory Access, DMA) , which allows hardware devices of different speeds to communicate without relying on the massive interrupt load of the central processing unit (Central Processing Unit, CPU). Otherwise, the CPU needs to replicate each piece of data from the source to the scratchpad, then write them back again to the new location, during which time the CPU is unavailable for other work. Therefore, the direct memory accessor 300 is used to store the computation graph. The direct memory accessor 300 can transmit the data of the off-chip memory to the on-chip memory, and can also transmit the data of the on-chip memory to the off-chip memory. In this embodiment, the direct memory accessor 300 receives and stores the computation graph from the off-chip memory. The data stream lake buffer region 100 is an on-chip memory, the data stream lake buffer region 100 includes a first data stream lake buffer 111 and a second data stream lake buffer 112, and the first data stream lake buffer 111 and the second data stream lake buffer 112 both can be used to cache computation graphs. The first fan-out device 400 can replicate one copy of data into two identical copies. The operation process of the arithmetic unit 200 includes the operation process in the convolutional neural network, such as convolution operation, pooling operation, activation function, etc., which is not limited in this embodiment of the present application. In the computation of the convolutional neural network, the computation graph can include many computing nodes. The arithmetic unit 200 obtains the next computing node by computing one computing node, and the next computing node will be used as the input of the next two computing nodes. That is, the next two computing nodes will be obtained by computing the next computing node through the arithmetic unit 200, i.e., the hierarchical operation in the convolutional neural network. In order to avoid the need of the operation between each layer that calls the data from the outside, which will cause a serious slowdown of the operation, the first data stream lake buffer 111 and the second data stream lake buffer 112 in the data stream lake buffer region 100 cache the intermediate data in turn to realize the accelerated operation of the convolutional neural network.

Exemplarily, when a computation graph needs to be computed, the DMA 300 will receive the first layer of computing nodes, which may be called by the CPU through an external storage device, and then the DMA 300 caches the first layer of computing nodes in the first data stream lake buffer 111. When the computation starts, the first data stream lake buffer 111 transmits the first layer of computing nodes to the arithmetic unit 200, and at the same time, the arithmetic unit 200 transmits the computing result of the first layer of computing nodes, i.e., the second layer of computing nodes to the first fan-out device 400, and the first fan-out device 400 replicates the second layer of computing nodes and transmits them to the direct memory accessor 300 and the second data stream lake buffer 112 respectively, and at this time, the first layer of computing nodes in the first data stream lake buffer 111 is still transmitting data to the arithmetic unit 200, and the arithmetic unit 200 is still performing computations, but the transmission of the first data stream lake buffer 111, the computation of the arithmetic unit 200, the replication of the first fan-out device 400, and the transmission to the direct memory accessor 300 and the second data stream lake buffer 112 are performed simultaneously to ensure fast operation. After the computation of the first layer of computing nodes is completed, there is no data stored in the first data stream lake buffer 111, the second layer of computing nodes are cached in the second data stream lake buffer 112, and the direct memory accessor 300 also stores the second layer of computing nodes, and at this time, the direct memory accessor 300 outputs the second layer of computing nodes to the external storage device, that is, the off-chip memory. The second data stream lake buffer 112 transmits the second layer of computing nodes to the arithmetic unit 200 to start the computation to obtain the third layer of computing nodes, and at the same time, the first fan-out device 400 replicates the third layer of the computing nodes and transmits them to the direct memory accessor 300 and the first data stream lake buffer 111 for caching, and so on. The arithmetic unit 200 obtains the i-th layer of computing nodes of the computation graph from the first data stream lake buffer 111 to perform computations to obtain the (i+1)-th layer of computing nodes, and at the same time, the first fan-out device 400 replicates the (i+1)-th layer of computing nodes and stores them in the direct memory accessor 300 and the second data stream lake buffer 112 respectively. The arithmetic unit 200 extracts the (i+1)-th layer of computing nodes from the second data stream lake buffer 112 for computation to obtain the (i+2)-th layer of computing nodes, and then the first fan-out device 400 continues to replicate the (i+2)-th layer of computing nodes and store them in the direct memory accessor 300 and the first data stream lake buffer 111, and simultaneously the arithmetic unit 200 extracts the (i+2)-th layer of computing nodes from the first data stream lake buffer 111 to perform computations to obtain the (i+3)-th layer of computing nodes. The above steps are repeated until the n-th layer of computing nodes are obtained, where 1≤i≤n-3, n≥4, i is a positive integer, and n is a positive integer.

Assuming that the flow rate of data from off-chip memory to on-chip memory is v1, the flow rate of data in the acceleration system is v2, and the flow rate of data from on-chip memory to off-chip memory is v3, under normal circumstances, due to the limitation of bandwidth, v1 is smaller than v2, and v3 is smaller than v2, which will cause insufficient data in the acceleration system to process in certain clock cycles, resulting arithmetic unit 200 in idle, and is unable to achieve maximum computing efficiency. However, since the acceleration system adopts the structure of this embodiment, the intermediate data does not need to be transmitted from the off-chip memory to the on-chip memory, nor does it need to be transmitted from the on-chip memory to the off-chip memory, but is directly stored in the data stream lake buffer region 100. In this way, it is ensured that enough data flows into the arithmetic unit 200 every moment, thereby ensuring full utilization of computing resources by the acceleration system based on the data flow architecture.

According to the embodiment of the present application, by configuring a direct memory accessor configured to store a computation graph, a data stream lake buffer region including a first data stream lake buffer and a second data stream lake buffer, an arithmetic unit configured to obtain an i-th layer of the computing nodes of the computation graph from the first data stream lake buffer for computation to obtain an (i+1)-th layer of the computing nodes, a first fan-out device configured to replicate the (i+1)-th layer of the computing nodes and store the (i+1)-th layer of the computing nodes in the direct memory accessor and the second data stream lake buffer respectively, i.e., caching intermediate data in turn through the first data stream lake buffer and the second data stream lake buffer in the data stream lake buffer region, there is no need to export intermediate data to the outside or call intermediate data from the outside, which greatly reduces the transmission time of the intermediate data, avoids the need for the convolutional neural network to frequently transmit the intermediate data to the off-chip memory during computation, and then transmit it back to the on-chip memory when needed, resulting in low utilization of computing resources and poor acceleration effects of the accelerator. In this case, the number of intermediate data which is transmitted to the off-chip memory is reduced to speed up the computation during the computation of the convolutional neural network.

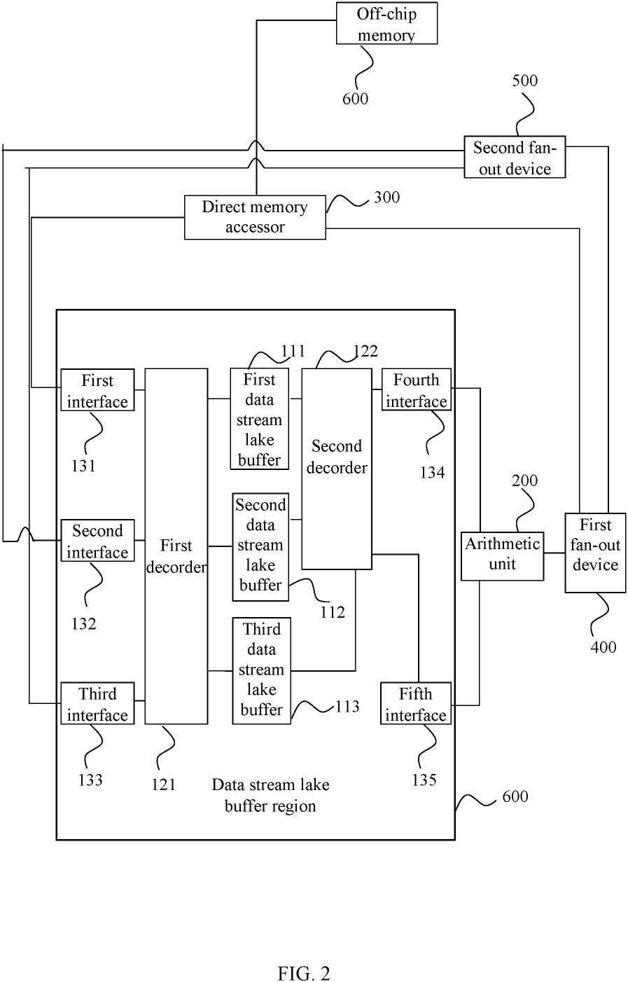

As shown in FIG. 2, another embodiment of the present application provides an acceleration system based on a convolutional neural network. The embodiment of the present application is further refined on the basis of the foregoing embodiments of the present application. The difference is that the convolutional neural network-based acceleration system also includes a second fan-out device 500.

In this embodiment, the convolutional neural network-based acceleration system further includes a second fan-out device 500, and the data stream lake buffer region 100 also includes a third data stream lake buffer 113. When computation of an (i+k)-th layer of the computing nodes of the computation graph needs to use an (i+j)-th layer of the computing nodes, the first fan-out device 400 respectively outputs the replicated (i+j)-th layer of the computing nodes to the second fan-out device 500 and the direct memory accessor 300, the second fan-out device 500 replicates the (i+j)-th layer of the computing nodes and respectively outputs the (i+j)-th layer of the computing nodes to the first data stream lake buffer 111 or the second data stream lake buffer 112, and the third data stream lake buffer 113, and the arithmetic unit 200 extracts the (i+j)-th layer of the computing nodes from the third data stream lake buffer 113, and extracts the (i+k)-th layer of the computing nodes from the first data stream lake buffer 111 or the second data stream lake buffer 112 for computation to obtain an (i+k+1)-th layer of the computing nodes. When computation of the (i+k)-th layer of the computing nodes of the computation graph does not need to use the (i+j)-th layer of the computing nodes, the second fan-out device 500 will not perform a replicate operation but directly output the (i+j)-th layer of the computing nodes to the first data stream lake buffer 111 or the second data stream lake buffer 112, where, k and j are positive integers respectively, i+k+1≤n, i+j≤n.

For example, the convolutional neural network-based acceleration system further includes an off-chip memory 600 configured to send the first layer of computing nodes to the direct memory accessor 300. The off-chip memory 600 is also configured to receive the (n-1)-thlayer of computing nodes sent by the direct memory accessor 300.

For example, the data stream lake buffer region 100 further includes a first decoder 121, a second decoder 122, a first interface 131, a second interface 132, a third interface 133, a fourth interface 134 and a fifth interface 135. The direct memory accessor 300 is connected to the first decoder 121 through the first interface 131, and the second fan-out device 500 is connected to the first decoder 121 through the second interface 132 and the third interface 133. The first decoder 121 is configured to cache the received data into the first data stream lake buffer 111, the second data stream lake buffer 112 or the third data stream lake buffer 113 respectively. The data in the first data stream lake buffer 111 and the second data stream lake buffer 112 are output from the fourth interface 134 to the arithmetic unit 200 through the second decoder 122, the data in the third data stream lake buffer 113 is output from the fifth interface 135 to the arithmetic unit 200 through the second decoder 122, and the arithmetic unit 200 is connected to the direct memory accessor 300 and the second fan-out device 500 through the first fan-out device 400 respectively.

For example, the main function of the off-chip memory 600 is to store various data, and to perform data access at high speed and automatically during operation on the computer or chip. The off-chip memory 600 is a device having a memory function and that uses a physical element with two stable states to store information. The storage capacity of the off-chip memory 600 should be large to meet the data computation demand of the neural network. For example, the off-chip memory 600 may be a Dynamic Random Access Memory (DRAM), or a Double Data Rate Synchronous Dynamic Random Access Memory (DDR SDRAM). For example, the off-chip memory 600 is a DDR SDRAM memory to meet higher data transmission efficiency. The direct memory accessor 300 can transmit the data in the data stream lake buffer region 100 to the off-chip memory 600, and can also transmit the data in the off-chip memory 600 to the data stream lake buffer region 100. In this embodiment, the off-chip memory 600 sends the first layer of computing nodes to the direct memory accessor 300 to be cached in the data stream lake buffer region 100 and computed by the arithmetic unit 200, and all the results computed by the arithmetic unit 200 will also be transmitted to the off-chip memory 600 through the direct memory accessor 300. The first decoder 121 and the second decoder 122 are a type of multiple-input multiple-output combinational logic circuit device, and the first decoder 121 can selectively input data from the first interface 131, the second interface 132 or the third interface 133 to the first data stream lake buffer 111, the second data stream lake buffer 112 or the third data stream lake buffer 113. The second decoder 122 can selectively output data from the first data stream lake buffer 111, the second data stream lake buffer 112 or the third data stream lake buffer 113 to the fourth interface 134 or the fifth interface 135. In this embodiment, the positions of the first interface 131, the second interface 132, the third interface 133, the fourth interface 134, the fifth interface 135, the first data stream lake buffer 111, the second data stream lake buffer 112, and the third data stream lake buffer 113 are not fixed and can be exchanged at will. That is, no matter that the data is transmitted from the first interface 131, the second interface 132 or the third interface 133, the first decoder 121 can arbitrarily transmit it to the first data stream lake buffer 111, the second data stream lake buffer 112 or the third data stream lake buffer 113, unless there is the data stored in the current data stream lake buffer and then the data will not be transmitted, and the second decoder 122 can also transmit the data in the first data stream lake buffer 111, the second data stream lake buffer 112 or the third data stream lake buffer 113 through the fourth interface 134 or the fifth interface 135 arbitrarily, unless there is data being transmitted on the current interface.

In an alternative embodiment, two data distributors may be provided instead of the first decoder 121 and two reverse data distributors may be provided instead of the second decoder 122 to achieve the same effect.

Exemplarily, when computation of the (i+k)-th layer of computing nodes of the computation graph needs to use the (i+j)-th layer of computing nodes, it is called a direct connection operation (shortcut). For example, when the fifth layer of computing nodes needs to use the second layer of computing nodes, the first layer of nodes is cached in the first data stream lake buffer 111 through the first interface 131 and selected by the first decoder 121. When the computation starts, the first data stream lake buffer 111 transmits the first-layer of computing nodes to the arithmetic unit 200 through the fourth interface 134 by the selection of the second decoder 122 to obtain the second layer of computing nodes, and at the same time, the arithmetic unit 200 outputs the second layer of computing nodes to the first fan-out device 400. The first fan-out device 400 replicates the second layer of computing nodes and transmits them to the direct memory accessor 300 and the second fan-out device 500 respectively, and the second fan-out device 500, by the control of the CPU, continues to replicate the second layer of computing nodes and transmit them to the second data stream lake buffer 112 through the second interface 132 and the first decoder 121, and transmit them to the third data stream lake buffer 113 through the third interface 133 and the first decoder 121. At this time, the second layer of computing nodes will be temporarily cached in the third data stream lake buffer 113 without participating in the operation, and then the second layer of computing nodes in the second data stream lake buffer 112 is transmitted to the arithmetic unit 200 to continue the computation through the second decoder 122 and the fourth interface 134 until the computation reaches the fifth layer of computing nodes. The fifth layer of computing nodes in the first data stream lake buffer is transmitted to the arithmetic unit 200 through the second decoder 122 and the fourth interface 134, while the second layer of computing nodes in the third data stream lake buffer 113 is transmitted to the arithmetic unit 200 through the second decoder 122 and the fifth interface 135. The arithmetic unit 200 performs computation to obtain the sixth layer of computing nodes according to the second layer computing nodes and the fifth layer of computing nodes, and caches it in the second data stream lake buffer 112 to complete the shortcut. When the sixth layer of computing nodes is computed, there is no cached data in the third data stream lake buffer 113 until the next shortcut is performed.

When there is no shortcut, the first fan-out device 400 replicates the computing nodes obtained by the arithmetic unit 200 and transmits them to the direct memory accessor 300 and the second fan-out device 500 respectively, but at this time, the second fan-out device 500, through the control of the CPU, will not replicate the computing nodes, but directly transmit the computing nodes to the second interface 132. For example, the first fan-out device 400 may also transmit two identical copies of the computing nodes to the direct memory accessor 300 through the control of the CPU, and the direct memory accessor 300 transmits one copy of the computing nodes to the off-chip memory 600, the other copy of computing nodes to the first interface 131.

In one embodiment, before each layer of computing nodes is transmitted to the data stream lake buffer region 100, the CPU will judge whether the computing nodes can be stored by the idle data stream lake buffer in the first data stream lake buffer 111, the second data stream lake buffer 112 or the second data stream lake buffer 112. If they cannot be stored, the CPU will control to split the nodes in chunks, and the chunks are transmitted to the data stream lake buffer region 100. A feasible implementation is that if there are two idle data stream lake buffers, that is, when no shortcut is executed, two data stream lake buffers can be used to cache a computing node. Another feasible implementation is that if the two data stream lake buffers cannot be stored, and there are two idle data stream lake buffers, that is, when the shortcut is not executed, the computing nodes obtained by the computation are first cached in the two idle data stream lake buffers, after the remaining data stream lake buffer has transmitted all the nodes to be computed to the arithmetic unit 200, cache the remaining compute nodes obtained through the computation into the remaining data stream lake buffer.

The embodiment of the present application uses three data stream lake buffers and two fan-out devices to flexibly allocate and use the data stream lake buffers in the data stream lake buffer region according to the needs of the convolutional neural network, avoiding need to retrieve data from the outside when the computation of the (i+k)-th layer of computing nodes of the computation graph needs to use the (i+j)-th layer during operation of the convolutional neural network, further reducing the waste of computing resources caused by data retrieval, which can flexibly handle intermediate data of convolutional neural networks to greatly improve computational efficiency.

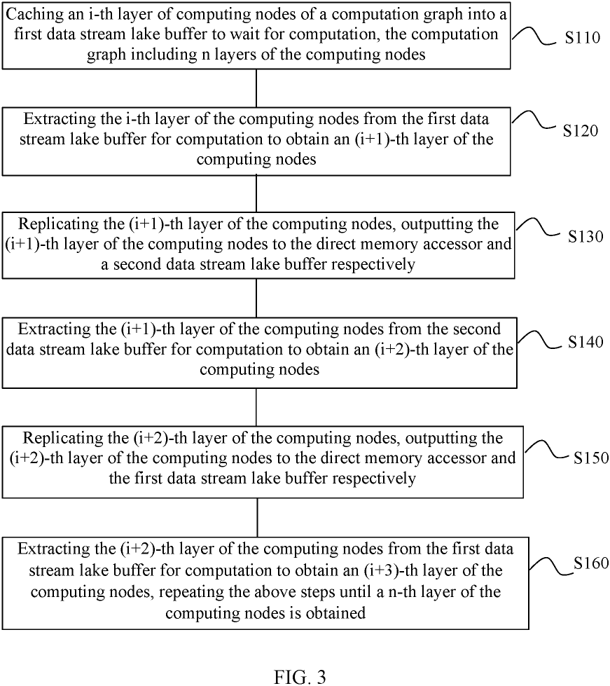

As shown in FIG. 3, an embodiment of the present application provides an acceleration method based on a convolutional neural network. The acceleration method based on a convolutional neural network includes:
S110. caching an i-th layer of computing nodes of a computation graph into a first data stream lake buffer to wait for computation, the computation graph including n layers of the computing nodes;
S120. extracting the i-th layer of the computing nodes from the first data stream lake buffer for computation to obtain an (i+1)-th layer of the computing nodes;
S130. replicating the (i+1)-th layer of the computing nodes, outputting the (i+1)-th layer of the computing nodes to the direct memory accessor and a second data stream lake buffer respectively;
S140. extracting the (i+1)-th layer of the computing nodes from the second data stream lake buffer for computation to obtain an (i+2)-th layer of the computing nodes;
S150. replicating the (i+2)-th layer of the computing nodes, outputting the (i+2)-th layer of the computing nodes to the direct memory accessor and the first data stream lake buffer respectively;
S160. extracting the (i+2)-th layer of the computing nodes from the first data stream lake buffer for computation to obtain an (i+3)-th layer of the computing nodes, repeating the above steps until a n-th layer of the computing nodes is obtained, where, 1≤i≤n-3, n≥4, i is a positive integer, and n is a positive integer.

In this embodiment, when a computation graph needs to be computed, the DMA will receive the first layer of computing nodes, which may be called by the CPU through an external storage device, and then the DMA caches the first layer of computing nodes in the first data stream lake buffer. When the computation starts, the first data stream lake buffer transmits the first layer of computing nodes to the arithmetic unit, and at the same time, the arithmetic unit transmits the computing result of the first layer of computing nodes, i.e., the second layer of computing nodes to the first fan-out device, and the first fan-out device replicates the second layer of computing nodes and transmits them to the direct memory accessor and the second data stream lake buffer respectively, and at this time, the first layer of computing nodes in the first data stream lake buffer is still transmitting data to the arithmetic unit, and the arithmetic unit is still performing computations, but the transmission of the first data stream lake buffer, the computation of the arithmetic unit, the replication of the first fan-out device, and the transmission to the direct memory accessor and the second data stream lake buffer are performed simultaneously to ensure fast operation. After the computation of the first layer of computing nodes is completed, there is no data stored in the first data stream lake buffer, the second layer of computing nodes are cached in the second data stream lake buffer, and the direct memory accessor also stores the second layer of computing nodes, and at this time, the direct memory accessor outputs the second layer of computing nodes to the external storage device, that is, the off-chip memory. The second data stream lake buffer transmits the second layer of computing nodes to the arithmetic unit to start the computation to obtain the third layer of computing nodes, and at the same time, the first fan-out device replicates the third layer of the computing nodes and transmits them to the direct memory accessor and the first data stream lake buffer for caching, and so on. The arithmetic unit obtains the i-th layer of computing nodes of the computation graph from the first data stream lake buffer to perform computations to obtain the (i+1)-th layer of computing nodes, and at the same time, the first fan-out device replicates the (i+1)-th layer of computing nodes and stores them in the direct memory accessor and the second data stream lake buffer respectively. The arithmetic unit extracts the (i+1)-th layer of computing nodes from the second data stream lake buffer for computation to obtain the (i+2)-th layer of computing nodes, and then the first fan-out device continues to replicate the (i+2)-th layer of computing nodes and store them in the direct memory accessor and the first data stream lake buffer, and simultaneously the arithmetic unit extracts the (i+2)-th layer of computing nodes from the first data stream lake buffer to perform computations to obtain the (i+3)-th layer of computing nodes, and the above steps are repeated until the n-th layer of computing nodes are obtained, where 1≤i≤n-3, n≥4, i is a positive integer, and n is a positive integer.

Assuming that the flow rate of data from off-chip memory to on-chip memory is v1, the flow rate of data in the accelerator is v2, and the flow rate of data from on-chip memory to off-chip memory is v3, under normal circumstances, due to the limitation of bandwidth, v1 is smaller than v2, and v3 is smaller than v2, which will cause insufficient data in the accelerator to process in certain clock cycles, resulting in the arithmetic unit 200 in idle, and is unable to achieve maximum computing efficiency. However, since the acceleration method of this embodiment is adopted, the intermediate data does not need to be transmitted from the off-chip memory to the on-chip memory, nor does it need to be transmitted from the on-chip memory to the off-chip memory, but is directly stored in the data stream lake buffer region. In this way, it is ensured that enough data flows into the arithmetic unit every moment, thereby ensuring full utilization of computing resources by the acceleration system based on the data flow architecture.

According to the embodiment of the present application, by caching an i-th layer of computing nodes of a computation graph into a first data stream lake buffer to wait for computation, the computation graph including n layers of the computing nodes; extracting the i-th layer of the computing nodes from the first data stream lake buffer for computation to obtain an (i+1)-th layer of the computing nodes; replicating the (i+1)-th layer of the computing nodes, outputting the (i+1)-th layer of the computing nodes to the direct memory accessor and a second data stream lake buffer respectively; extracting the (i+1)-th layer of the computing nodes from the second data stream lake buffer for computation to obtain an (i+2)-th layer of the computing nodes; replicating the (i+2)-th layer of the computing nodes, outputting the (i+2)-th layer of the computing nodes to the direct memory accessor and the first data stream lake buffer respectively; extracting the (i+2)-th layer of the computing nodes from the first data stream lake buffer for computation to obtain an (i+3)-th layer of the computing nodes, repeating the above steps until a n-th layer of the computing nodes is obtained, where, 1≤i≤n-3, n≥4, i is a positive integer, and n is a positive integer. That is, by caching intermediate data in turn through the first data stream lake buffer and the second data stream lake buffer in the data stream lake buffer region, there is no need to export intermediate data to the outside or call intermediate data from the outside, which greatly reduces the transmission time of the intermediate data, avoids the need for the convolutional neural network to frequently transmit the intermediate data to the off-chip memory during computation, and then transmit it back to the on-chip memory when needed, resulting in low utilization of computing resources and poor acceleration effects of the accelerator. In this case, the number of intermediate data which is transmitted to the off-chip memory is reduced to speed up the computation during the computation of the convolutional neural network.

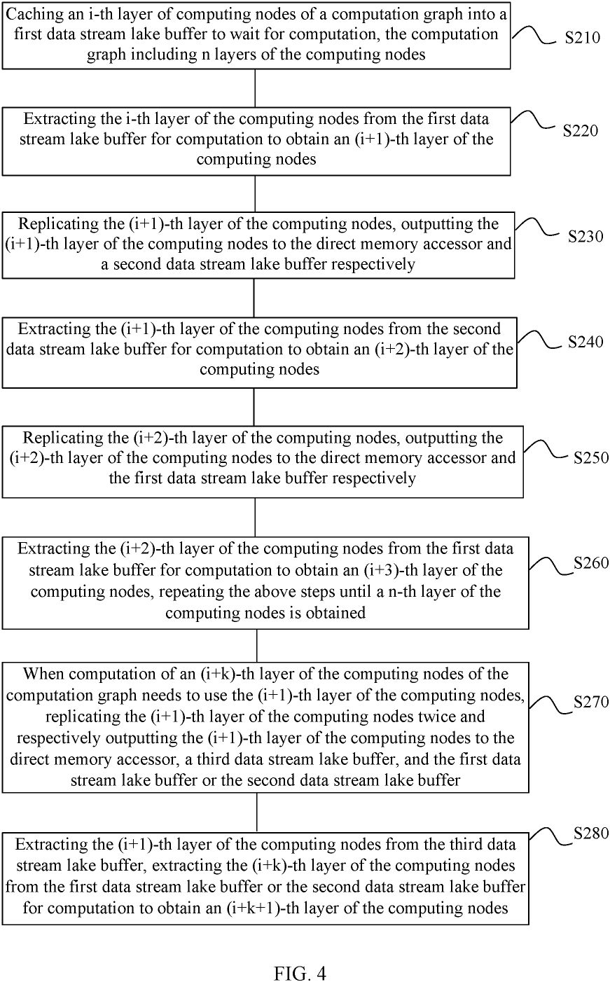

As shown in FIG. 4, another embodiment of the present application provides an acceleration system based on a convolutional neural network. The embodiment of the present application is further refined on the basis of the aforementioned embodiments of the present application. The acceleration method based on a convolutional neural network includes:
S210. caching an i-th layer of computing nodes of a computation graph into a first data stream lake buffer to wait for computation, the computation graph including n layers of the computing nodes;
S220. extracting the i-th layer of the computing nodes from the first data stream lake buffer for computation to obtain an (i+1)-th layer of the computing nodes;
S230. replicating the (i+1)-th layer of the computing nodes, outputting the (i+1)-th layer of the computing nodes to the direct memory accessor and a second data stream lake buffer respectively;
S240. extracting the (i+1)-th layer of the computing nodes from the second data stream lake buffer for computation to obtain an (i+2)-th layer of the computing nodes;
S250. replicating the (i+2)-th layer of the computing nodes, outputting the (i+2)-th layer of the computing nodes to the direct memory accessor and the first data stream lake buffer respectively;
S260. extracting the (i+2)-th layer of the computing nodes from the first data stream lake buffer for computation to obtain an (i+3)-th layer of the computing nodes, repeating the above steps until a n-th layer of the computing nodes is obtained, where, 1≤i≤n-3, n≥4, i is a positive integer, and n is a positive integer.

Steps S210-S260 of the embodiment of the present application are the same as the implementation method of the foregoing embodiment of the application.

S270. When computation of an (i+k)-th layer of the computing nodes of the computation graph needs to use the (i+1)-th layer of the computing nodes, replicating the (i+1)-th layer of the computing nodes twice and respectively outputting the (i+1)-th layer of the computing nodes to the direct memory accessor, a third data stream lake buffer, and the first data stream lake buffer or the second data stream lake buffer.

S280. Extracting the (i+1)-th layer of the computing nodes from the third data stream lake buffer, extracting the (i+k)-th layer of the computing nodes from the first data stream lake buffer or the second data stream lake buffer for computation to obtain an (i+k+1)-th layer of the computing nodes.

For example, the first-layer of computing nodes of the computation graph is obtained through the off-chip memory. When the direct memory accessor obtains a layer of computing nodes, it outputs the same to the off-chip memory.

In this embodiment, when a computation graph needs to be computed, the DMA will receive the first layer of computing nodes, which may be called by the CPU through an external storage device, and then the DMA caches the first layer of computing nodes in the first data stream lake buffer. When the computation starts, the first data stream lake buffer transmits the first layer of computing nodes to the arithmetic unit, and at the same time, the arithmetic unit transmits the computing result of the first layer of computing nodes, i.e., the second layer of computing nodes to the first fan-out device. The first fan-out device replicates the second layer of computing nodes and transmits them to the direct memory accessor and the second data stream lake buffer respectively, and at this time, the first layer of computing nodes in the first data stream lake buffer is still transmitting data to the arithmetic unit, and the arithmetic unit is still performing computations, but the transmission of the first data stream lake buffer, the computation of the arithmetic unit, the replication of the first fan-out device, and the transmission to the direct memory accessor and the second data stream lake buffer are performed simultaneously to ensure fast operation. After the computation of the first layer of computing nodes is completed, there is no data stored in the first data stream lake buffer, the second layer of computing nodes are cached in the second data stream lake buffer, and the direct memory accessor also stores the second layer of computing nodes, and at this time, the direct memory accessor outputs the second layer of computing nodes to the external storage device, that is, the off-chip memory. The second data stream lake buffer transmits the second layer of computing nodes to the arithmetic unit to start the computation to obtain the third layer of computing nodes, and at the same time, the first fan-out device replicates the third layer of the computing nodes and transmits them to the direct memory accessor and the first data stream lake buffer for caching, and so on. The arithmetic unit obtains the i-th layer of computing nodes of the computation graph from the first data stream lake buffer to perform computations to obtain the (i+1)-th layer of computing nodes, and at the same time, the first fan-out device replicates the (i+1)-th layer of computing nodes and stores them in the direct memory accessor and the second data stream lake buffer respectively. The arithmetic unit extracts the (i+1)-th layer of computing nodes from the second data stream lake buffer for computation to obtain the (i+2)-th layer of computing nodes, and then the first fan-out device continues to replicate the (i+2)-th layer of computing nodes and store them in the direct memory accessor and the first data stream lake buffer, and simultaneously the arithmetic unit extracts the (i+2)-th layer of computing nodes from the first data stream lake buffer to perform computations to obtain the (i+3)-th layer of computing nodes, and the above steps are repeated until the n-th layer of computing nodes are obtained, where 1≤i≤n-3, n≥4, i is a positive integer, and n is a positive integer.

The embodiment of the present application, by when computation of an (i+k)-th layer of the computing nodes of the computation graph needs to use the (i+1)-th layer of the computing nodes, replicating the (i+1)-th layer of the computing nodes twice and respectively outputting the (i+1)-th layer of the computing nodes to the direct memory accessor, a third data stream lake buffer, and the first data stream lake buffer or the second data stream lake buffer; extracting the (i+1)-th layer of the computing nodes from the third data stream lake buffer, extracting the (i+k)-th layer of the computing nodes from the first data stream lake buffer or the second data stream lake buffer for computation to obtain an (i+k+1)-th layer of the computing nodes, avoids need to retrieve data from the outside when the computation of the (i+k)-th layer of computing nodes of the computation graph needs to use the (i+j)-th layer during operation of the convolutional neural network, flexibly allocates and uses the data stream lake buffers in the data stream lake buffer region according to the needs of the convolutional neural network, thereby further reducing the waste of computing resources caused by data retrieval, and can flexibly handle intermediate data of convolutional neural networks to greatly improve computational efficiency.

The embodiment of the present application also provides a computer-readable storage medium, on which a computer program is stored. When the program is executed by a processor, the acceleration method provided by all the embodiments of the present application is implemented:
caching an i-th layer of computing nodes of a computation graph into a first data stream lake buffer to wait for computation, the computation graph including n layers of the computing nodes;
extracting the i-th layer of the computing nodes from the first data stream lake buffer for computation to obtain an (i+1)-th layer of the computing nodes;
replicating the (i+1)-th layer of the computing nodes, outputting the (i+1)-th layer of the computing nodes to the direct memory accessor and a second data stream lake buffer respectively;
extracting the (i+1)-th layer of the computing nodes from the second data stream lake buffer for computation to obtain an (i+2)-th layer of the computing nodes;
replicating the (i+2)-th layer of the computing nodes, outputting the (i+2)-th layer of the computing nodes to the direct memory accessor and the first data stream lake buffer respectively;
extracting the (i+2)-th layer of the computing nodes from the first data stream lake buffer for computation to obtain an (i+3)-th layer of the computing nodes, repeating the above steps until a n-th layer of the computing nodes is obtained, where, 1≤i≤n-3, n≥4, i is a positive integer, and n is a positive integer.

The computer storage medium in the embodiments of the present application may use any combination of one or more computer readable media. The computer readable medium may be a computer readable signal medium or a computer readable storage medium. A computer readable storage medium may be, for example, but not limited to, an electrical, magnetic, optical, electromagnetic, infrared, or semiconductor system, apparatus, or device, or any combination thereof. More specific examples (a non-exhaustive list) of computer readable storage media include: electrical connections with one or more conductive wires, portable computer disks, hard disks, random access direct memory accessor (RAM), read-only direct memory accessor (ROM), erasable programmable read-only direct memory accessor (EPROM or flash memory), fiber optics, portable compact disk read-only direct memory accessor (CD-ROM), optical direct memory accessor, magnetic direct memory accessor, or any suitable combination of the above. In this disclosure, a computer-readable storage medium may be any tangible medium that contains or stores a program that can be used by or in conjunction with an instruction execution system, apparatus, or device.

A computer readable signal medium may include a data signal carrying computer readable program code in the baseband or as part of a carrier wave. Such propagated data signals may take many forms, including but not limited to electromagnetic signals, optical signals, or any suitable combination of the foregoing. A computer-readable signal medium may also be any computer-readable medium other than a computer-readable storage medium, which can send, propagate, or transmit a program for use by or in conjunction with an instruction execution system, apparatus, or device.

Program code embodied on a computer readable medium may be transmitted using any appropriate medium, including, but not limited to wireless, wire, optical fiber cable, RF, etc., or any suitable combination of the foregoing.

Computer program code for performing the operations of the present application may be written in one or more programming languages or combinations thereof, including object-oriented programming languages, such as Java, Smalltalk, C++, and conventional Procedural Programming Language, such as “C” or a similar programming language. The program code may execute entirely on the user’s computer, partly on the user’s computer, as a stand-alone software package, partly on the user’s computer and partly on a remote computer, or entirely on the remote computer or server. In cases involving a remote computer, the remote computer can be connected to the user computer through any kind of network, including a local area network (LAN) or a wide area network (WAN), or it can be connected to an external computer (such as through Internet connection by using an Internet service provider).

Note that the above are only exemplary embodiments and applied technical principles of the present application. Those skilled in the art will understand that the present application is not limited to the specific embodiments described herein, and various obvious changes, readjustments and substitutions can be made by those skilled in the art without departing from the protection scope of the present application. Therefore, although the present application has been described in more detail through the above embodiments, the present application is not limited to the above embodiments, and can also include more other equivalent embodiments without departing from the concept of the present application. The scope of the present application is determined by the scope of the appended claims.

What is claimed is:

1. An acceleration system based on a convolutional neural network, comprising:
a direct memory accessor configured to store a computation graph, the computation graph comprising n layers of computing nodes;
a data stream lake buffer region, comprising a first data stream lake buffer and a second data stream lake buffer, the first data stream lake buffer being configured to cache an i-th layer of the computing nodes of the computation graph;
an arithmetic unit configured to obtain the i-th layer of the computing nodes of the computation graph from the first data stream lake buffer for computation to obtain an (i+1)-th layer of the computing nodes;
a first fan-out device configured to replicate the (i+1)-th layer of the computing nodes and store the (i+1)-th layer of the computing nodes in the direct memory accessor and the second data stream lake buffer respectively, and the arithmetic unit extracting the (i+1)-th layer of the computing nodes from the second data stream lake buffer for computation to obtain an (i+2)-th layer of the computing nodes;
wherein the first fan-out device is further configured to replicate the (i+2)-th layer of the computing nodes and store the (i+2)-th layer of the computing nodes in the direct memory accessor and the first data stream lake buffer, the arithmetic unit extracts the (i+2)-th layer of the computing nodes from the first data stream lake buffer for computation to obtain an (i+3)-th layer of the computing nodes, and above steps are repeated until a n-th layer of the computing nodes is obtained;
wherein, 1≤i≤n-3, n≥4, i is a positive integer, and n is a positive integer.

2. The acceleration system according to claim 1, further comprising a second fan-out device, the data stream lake buffer region further comprising a third data stream lake buffer;
wherein in a case that computation of an (i+k)-th layer of the computing nodes of the computation graph needs to use an (i+j)-th layer of the computing nodes, the first fan-out device respectively outputs the (i+j)-th layer of the computing nodes replicated to the second fan-out device and the direct memory accessor, the second fan-out device replicates the (i+j)-th layer of the computing nodes and respectively outputs the (i+j)-th layer of the computing nodes to the first data stream lake buffer or the second data stream lake buffer, and the third data stream lake buffer, and the arithmetic unit extracts the (i+j)-th layer of the computing nodes from the third data stream lake buffer, and extracts the (i+k)-th layer of the computing nodes from the first data stream lake buffer or the second data stream lake buffer for computation to obtain an (i+k+1)-th layer of the computing nodes;
in a case that computation of the (i+k)-th layer of the computing nodes of the computation graph does not need to use the (i+j)-th layer of the computing nodes, the second fan-out device will not perform a replicate operation but directly output the (i+j)-th layer of the computing nodes to the first data stream lake buffer or the second data stream lake buffer;
wherein, k and j are positive integers respectively, i+k+1≤n, i+j≤n.

3. The acceleration system according to claim 1, further comprising an off-chip memory configured to send a first layer of the computing nodes to the direct memory accessor.

4. The acceleration system according to claim 3, wherein the off-chip memory is further configured to receive a (n-1)-th layer of the computing nodes sent by the direct memory accessor.

5. The acceleration system according to claim 2, wherein the data stream lake buffer region further comprises a first decoder, a second decoder, a first interface, a second interface, a third interface, and a fourth interface and a fifth interface, the direct memory accessor is connected to the first decoder through the first interface, and the second fan-out device is connected to the first decoder through the second interface and the third interface, the first decoder is configured to respectively cache received data into the first data stream lake buffer, the second data stream lake buffer or the third data stream lake buffer, the data in the first data stream lake buffer and the second data stream lake buffer is output from the fourth interface to the arithmetic unit through the second decoder, and the data in the third data stream lake buffer is output from the fifth interface to the arithmetic unit through the second decoder, and the arithmetic unit is respectively connected to the direct memory accessor and the second fan-out device through the first fan-out device.

6. An acceleration method based on a convolutional neural network, comprising:
caching an i-th layer of computing nodes of a computation graph into a first data stream lake buffer to wait for computation, the computation graph comprising n layers of the computing nodes;
extracting the i-th layer of the computing nodes from the first data stream lake buffer for computation to obtain an (i+1)-th layer of the computing nodes;
replicating the (i+1)-th layer of the computing nodes, outputting the (i+1)-th layer of the computing nodes to a direct memory accessor and a second data stream lake buffer respectively;
extracting the (i+1)-th layer of the computing nodes from the second data stream lake buffer for computation to obtain an (i+2)-th layer of the computing nodes;
replicating the (i+2)-th layer of the computing nodes, outputting the (i+2)-th layer of the computing nodes to the direct memory accessor and the first data stream lake buffer respectively;
extracting the (i+2)-th layer of the computing nodes from the first data stream lake buffer for computation to obtain an (i+3)-th layer of the computing nodes, repeating above steps until a n-th layer of the computing nodes is obtained;
wherein, 1≤i≤n-3, n≥4, i is a positive integer, and n is a positive integer.

7. The acceleration method according to claim 6, further comprising:
in a case that computation of an (i+k)-th layer of the computing nodes of the computation graph needs to use the (i+1)-th layer of the computing nodes, replicating the (i+1)-th layer of the computing nodes twice and respectively outputting the (i+1)-th layer of the computing nodes to the direct memory accessor, a third data stream lake buffer, and the first data stream lake buffer or the second data stream lake buffer;
extracting the (i+1)-th layer of the computing nodes from the third data stream lake buffer, extracting the (i+k)-th layer of the computing nodes from the first data stream lake buffer or the second data stream lake buffer for computation to obtain an (i+k+1)-th layer of the computing nodes;
wherein, k and j are positive integers respectively, i+k+1≤n, i+j≤n.

8. The acceleration method according to claim 6, further comprising: obtaining a first layer of the computing nodes of the computation graph through an off-chip memory.

9. The acceleration method according to claim 8, wherein when the direct memory accessor obtains a layer of the computing nodes, the obtained layer of the computing nodes is output to the off-chip memory.

10. A computer-readable storage medium, wherein a computer program is stored thereon, and when the computer program is executed by a processor, the acceleration method according to claim 6 is implemented.

11. The computer-readable storage medium according to claim 10, further comprising:
in a case that computation of an (i+k)-th layer of the computing nodes of the computation graph needs to use the (i+1)-th layer of the computing nodes, replicating the (i+1)-th layer of the computing nodes twice and respectively outputting the (i+1)-th layer of the computing nodes to the direct memory accessor, a third data stream lake buffer, and the first data stream lake buffer or the second data stream lake buffer;
extracting the (i+1)-th layer of the computing nodes from the third data stream lake buffer, extracting the (i+k)-th layer of the computing nodes from the first data stream lake buffer or the second data stream lake buffer for computation to obtain an (i+k+1)-th layer of the computing nodes;
wherein, k and j are positive integers respectively,
$$i + k + 1 ⩽ n , i + j ⩽ n$$
.

12. The computer-readable storage medium according to claim 10, further comprising: obtaining a first layer of the computing nodes of the computation graph through an off-chip memory.

13. The computer-readable storage medium according to claim 12, wherein when the direct memory accessor obtains a layer of the computing nodes, the obtained layer of the computing nodes is output to the off-chip memory.
